(19) United States
(12) Patent Application Publication
(10) Pub. No.: US 2024/0084843 A1
(43) Pub. Date: Mar. 14, 2024

(54) Adjustable Clamping Hook for Brick Walls

(71) Applicant: Scott Sullivan, San Francisco, CA (US)

(72) Inventor: Scott Sullivan, San Francisco, CA (US)

(21) Appl. No.: 18/368,490

(22) Filed: Sep. 14, 2023

Related U.S. Application Data
(60) Provisional application No. 63/406,697, filed on Sep. 14, 2022.

(51) Int. Cl. F16B 45/00

(52) U.S. Cl. CPC F16B 45/015

(57) ABSTRACT

A clamping wall hook for securing to one brick of a brick wall, or any suitable wall structure having a top surface and a bottom surface. The wall hook includes a body having lower teeth positioned to engage the bottom surface of the brick, an upper jaw member having upper teeth for engaging the top surface of the brick. A handle is pivotally attached to the body between a locked and unlocked position and includes a hook structure that can be used to support hanging items. The upper jaw member is pivotally attached to the handle so that a clamping force is generated on the brick when the handle is positioned in the locked position, and released when the handle is positioned in its unlocked position.

### BACKGROUND OF THE INVENTION

### a) Field of the Invention

This invention relates generally to brackets, clips, and the like for supporting objects against a wall, and, in particular, to such devices specifically for securing items to a brick wall.

### b) Description of the Related Art

Home construction in the US and many other countries of the world enjoy the use of a variety of sizes and types of brick to form walls, either structural load bearing walls, or just decorative ones. There are numerous types of brick that are named for their use, size, forming method, origin, quality, texture, and/or materials. Most types of construction brick are actually hidden from normal view within the wall structure or buried in the ground and are not intended to be seen. So called face-brick, however, is meant to be seen and is typically used on the outside of a wall. It is to this type of brick that various items are typically secured, as desired by a home owner, including holiday lights, wreaths, garland, decorations, banners, signs, and even planters.

Although there many different shapes and sizes of face brick, in the United States, the most common shape is box-rectangular and the most common specified vertical height measurement is 2¼ inches. A typical brick wall construction includes a plurality of horizontally disposed rows of brick, stacked parallel on each other, and further staggered so that the ends of brick of one row avoid aligning with the ends of brick of either upper or lower adjacent row. A vertical mortar joint, called a “head joint” is established between adjacent brick ends along each row, and a horizontal mortar joint, called a “bed joint” is similarly established between rows of brick. The width of the mortar joints will vary from wall to wall, but according to the ASTM Standard, to maximize compressive and flexural strength both the head and bed mortar joints should be ⅜ inches.

Owing to the hardness of the brick material, a home owner has few conventional choices to secure a decoration thereto. Various brackets, nails, bolts and similar fastening devices are known to be used for supporting objects from brick and mortar walls. However, such fastening devices typically encounter numerous problems during installation, use and removal. Masonry nails, for example, are specially hardened nails that can penetrate concrete and brick using just a hammer. Unfortunately, inserting a masonry nail into a masonry wall may easily cause damage to the brick or mortar, usually chips and cracks. Once a crack forms, the brick or surrounding mortar may loosen, especially when a heavy object is attached to the fastener. If the mortar becomes cracked, water may enter the crack during warm months, and freeze and expand during winter, extending the damage. Also, such nails are not designed to be easily or regularly removed, as may be desired by the home owner, when a seasonal decoration is taken down and stored.

Special fasteners such as expansion screws and lag bolts are often used to provide a secure anchor on the masonry wall. Special purpose fasteners are difficult to install and usually require pre-drilling holes in the wall prior to installation of the device. Similar to cracks, water can enter such a hole and if the penetrated water becomes frozen, resulting expansion forces can easily cause significant damage to the mortar and brick. Special purpose fasteners are usually permanently secured to the wall and are not removable without causing considerable damage to the wall, and are therefore considered inflexible should the user wish to rearrange the hung item.

In addition, the use of adhesive-based, non-permanent wall hooks has been generally undesirable, both aesthetically and functionally. The adhesive of such hooks reliably fails to achieve a secure bond to the unpredictable texture of the porous brick surface and therefore cannot hold any item of any weight with any confidence.

In response to an apparent need to provide an easy way to quickly and easily secure an item to a brick wall without requiring hand-tools or otherwise drilling into the brick, secure clip-like devices were developed. One example of such a device, as disclosed in U.S. Pat. No. 4,201,013 to Robbins, is a wire clip having a pair of bent end portions and an intermediate outwardly projecting portion formed as a loop for retaining a plant vine. The device may be simply installed on a brick wall without damaging the wall, but is limited in the amount of weight it can support. If an object such as a picture were suspended from the loop the downward pressure exerted on the loop would pull the end portions away from the brick.

Another clip device for holding objects on a brick wall is disclosed in U.S. Pat. No. 4,145,840 to Davidson. Davidson discloses a U-shaped clip of spring steel having two legs for engaging opposite surfaces of adjacent bricks across a mortar joint. The clip is intended only for non-load bearing applications such as fastening plant vines to a wall. If an object of substantial weight is placed on the clip the downward force would cause the upper leg to be pulled forward and become disengaged from the mortar joint.

The brick clips of the prior art fail to grip onto a brick surface with a clamping force that can support a heavy load and overcome lateral forces created by wind, in outdoor applications, and which can be easily attached and removed, without the use of tools.

Accordingly, there has been a need for some period of time for a fastening device which is easy to install on brick walls, which permits flexibility for rearrangement and which leaves no opening or other defacing features when removed.

It is an object of the present invention to provide a hook clip for hanging select items from a brick wall.

It is a second object of the present invention to provide such a hook clip that positively engages an upper and lower surfaces of a select brick of the wall and mechanically clamps onto the brick to provide a secure hook for hanging such items.

It is another object of the present invention to provide such a hook clip which positively engages a brick wall without the need of tools and which can be quickly and easily attached and removed.

It is yet another object of the present invention to provide such a hook clip which includes means to quickly and easily adjust for different size bricks.

The features of this invention, and the manner of attaining them, will become more apparent and the invention itself will be better understood by reference to the following description of the disclosed embodiments taken in conjunction with the accompanying drawings.

### SUMMARY OF THE INVENTION

A clamping wall hook for securing to one brick of a brick wall, or any suitable wall structure having a top surface and a bottom surface. The wall hook includes a body having lower teeth positioned to engage the bottom surface of the brick, an upper jaw member having upper teeth for engaging the top surface of the brick. A handle is pivotally attached to the body between a locked and unlocked position and includes a hook structure that can be used to support hanging items. The upper jaw member is pivotally attached to the handle so that a clamping force is generated on the brick when the handle is positioned in the locked position, and released when the handle is positioned in its unlocked position.

The handle and jaw member are pivotally attached along offset axes so that an over-center condition is met when the handle is moved to the locked position. The over-center condition pulls the handle into the body and holds the handle in the locked position. The over-center condition is released while pivoting the handle from the locked position to the unlocked position.

The upper jaw member includes an integral spring and a linear adjustment mechanism, which preferably includes a ratchet and pin. This allows the distance between the upper and lower teeth to be quickly and easily adjusted, depending on the height of the brick. The spring is what generates the clamping force to exert onto the brick, firmly engaging the upper and lower teeth into the brick's surfaces, to securely attach the hook to the wall.

### BRIEF DESCRIPTION OF THE DRAWINGS

FIG. 1 is a perspective assembly view of the brick clip hook, according to the present invention, showing assembly details of the four main parts, a base, a handle, a ratchet arm, and an adjustable jaw;

FIG. 2 is a front, left perspective view of an assembled brick clip hook, shown in the open, unclamped position, according to the present invention;

FIG. 3 is a plan view of a flat blank cutout of the base part of the present brick clip hook, prior to being formed, showing the location of various fold lines, according to the present invention;

FIG. 4 is a plan view of a flat blank cutout of the handle part of the present brick clip hook, prior to being formed, showing the location of various fold lines, according to the present invention;

FIG. 5 is a side profile view of a formed handle part, showing the profile shaped used to form the blank of FIG. 4 into the final part, according to the present invention;

FIG. 6 is a plan view of a flat blank cutout of the ratchet arm of the present brick clip hook, prior to being formed, showing the location of various fold lines, according to the present invention;

FIG. 7 is a side profile view of a formed ratchet arm, showing the profile shaped used to form the blank of FIG. 6 into the final part, according to the present invention;

FIG. 8 is a plan view of a flat blank cutout of the adjustable jaw of the present brick clip hook, prior to being formed, showing the location of various fold lines, according to the present invention;

FIGS. 9a-9d are perspective views of the adjustable jaw and ratchet arm, illustrating the steps to move the adjustable jaw relative to the ratchet arm from a first relative position, as shown in FIG. 9a to a second relative position, as shown in FIG. 9d, by first sliding the adjustable jaw to the left, as shown in FIG. 9b and then moving the adjustable jaw longitudinally along the ratchet arm to a new position, as shown in FIG. 9c, and finally sliding the adjustable jaw to the right to engage with the ratchet arm in the new position, as shown in FIG. 9d, according to the present invention;

FIG. 10 is a front, right perspective view of an assembled brick clip hook, shown in the open, unclamped position, according to the present invention;

FIG. 11 is a front, right perspective view of an assembled brick clip hook, shown in the closed, clamped position, according to the present invention;

FIG. 12 is a rear, right perspective view of an assembled brick clip hook, shown in the closed, clamped position, according to the present invention;

FIG. 13 is a side view of the brick clip hook of FIG. 10, shown positioned within the mortar gaps of the exemplary brick wall, and shown in an open, unclamped position, according to the present invention;

FIG. 14 is a side view of the brick clip hook of FIG. 10, shown positioned within the mortar gaps of the exemplary brick wall, and shown in a closed, and clamped position, according to the present invention;

FIG. 15 is a perspective view of a brick clip hook, according to the present invention, shown secured to an exemplary brick wall having a certain size brick height, and shown supporting a cable of an hanging item (not shown);

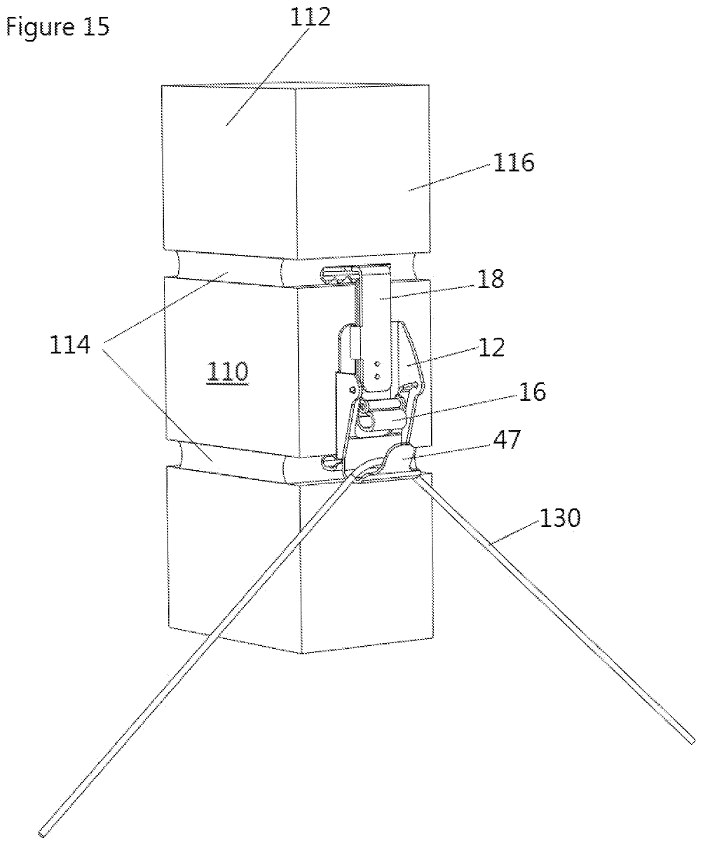

FIG. 16 is an enlarged perspective view of the brick clip hook of FIG. 15, showing details of the components, according to the present invention;

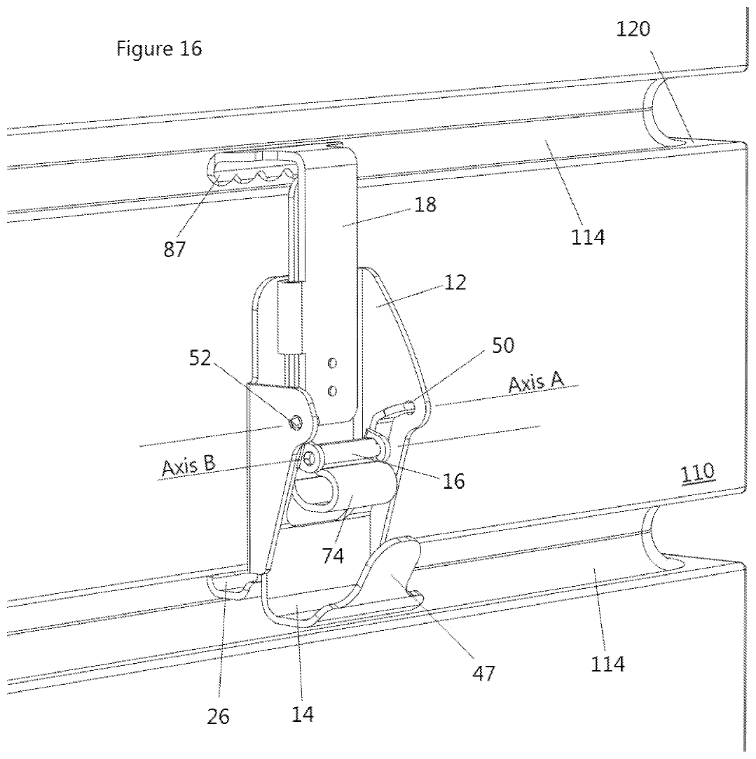

FIG. 17 is a side sectional view of the brick clip hook, shown in an open, unclamped position, and showing details of an over-center locking mechanism, according to the present invention; and

FIG. 18 is a side sectional view of the brick clip hook, shown in a closed and clamped position, and showing details of an over-center locking mechanism, according to the present invention.

### DETAILED DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

As an overview, the present invention is a brick clip hook which allows a user to secure an item to a brick wall simply by clamping the present clip vertically to one of the bricks making up the wall. The clip, according to the invention, includes two opposing and inwardly directed gripping teeth which may be mechanically displaced between an open position, wherein the clip may be positioned about a brick of a wall, and a closed, clamping position, wherein the clip mechanically forces the two opposing sets of gripping teeth to move towards each other and thereby firmly grip a selected brick of the wall. Once the present brick clip hook is firmly gripped onto the brick of the wall, an integral hook portion of the clip may then be used to support an item to be hung from the wall.

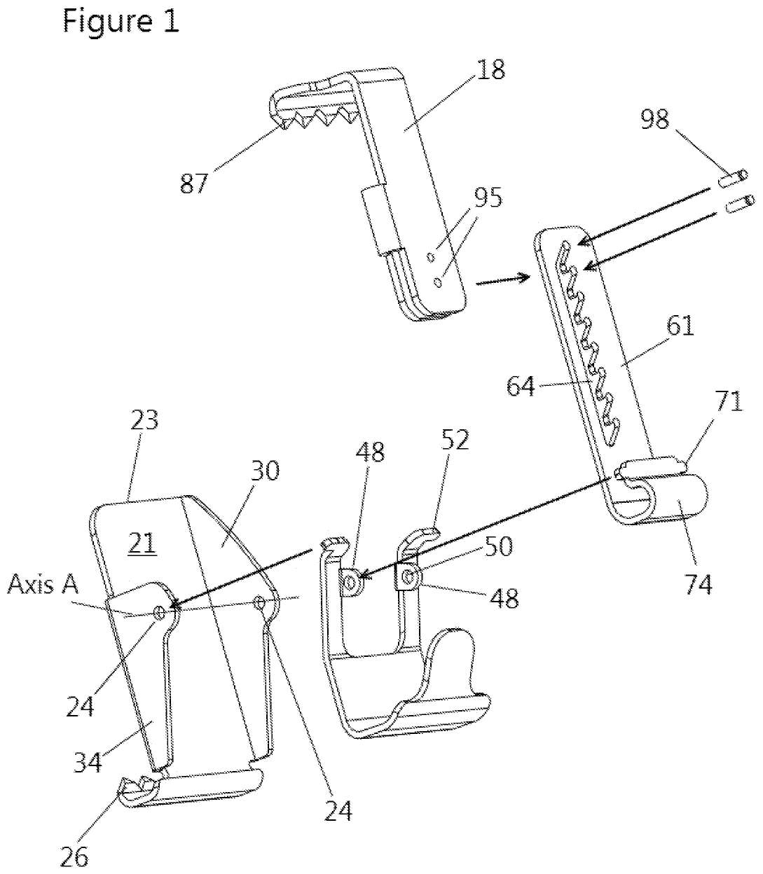

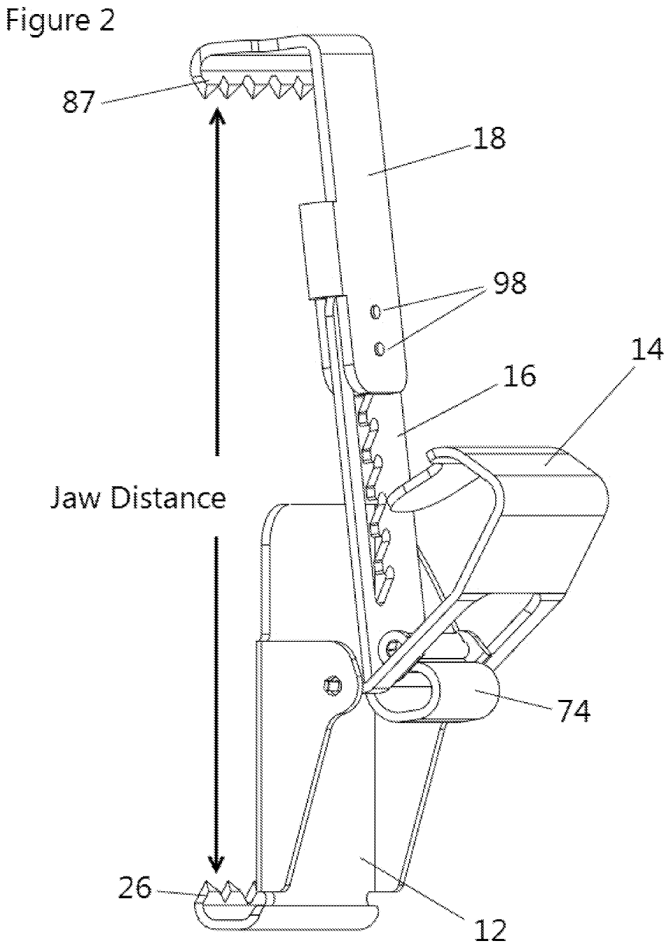

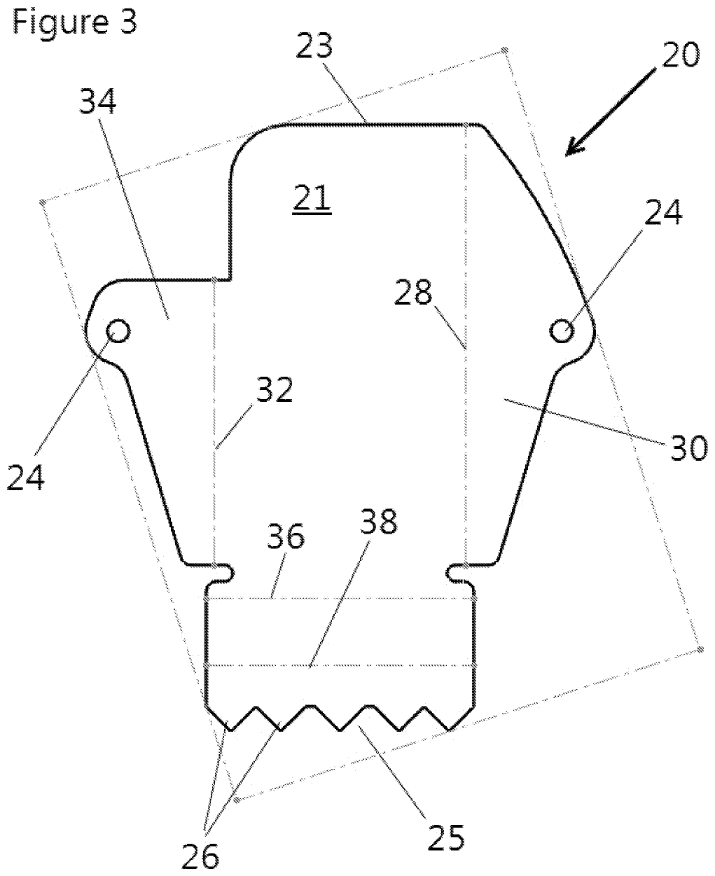

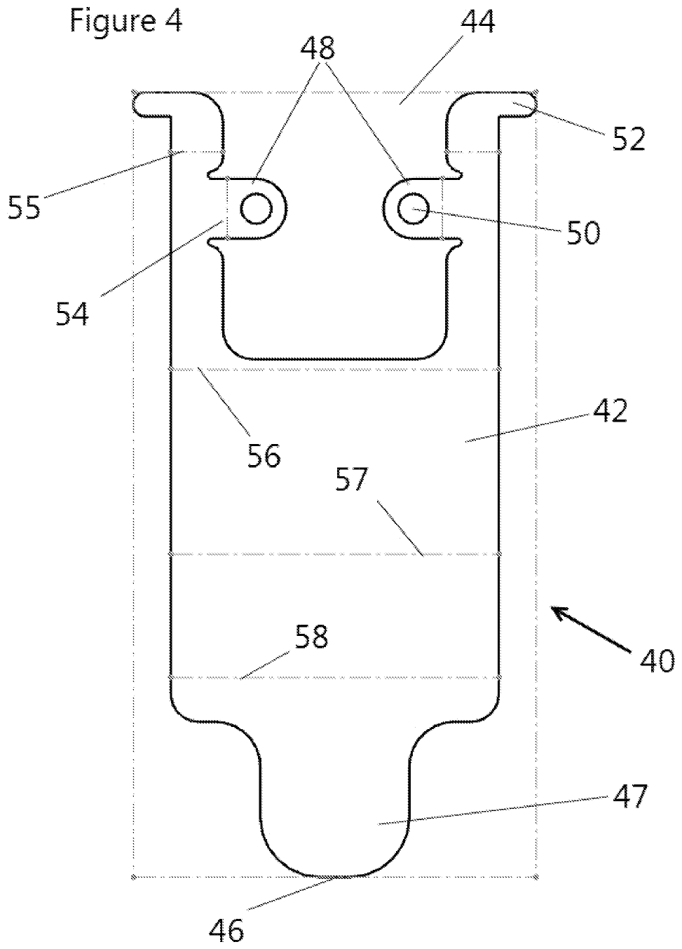

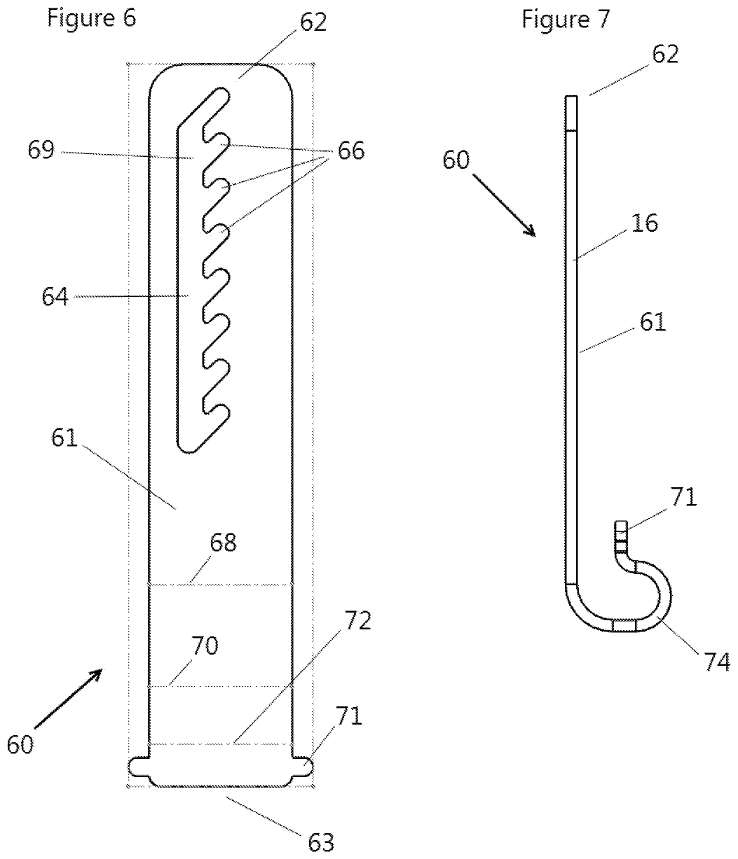

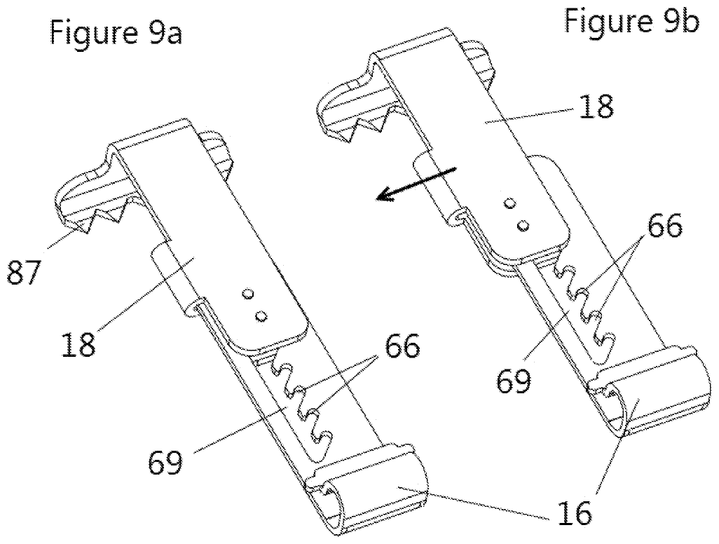

Referring to FIGS. 1 and 2, a brick clip hook 10, according to the invention is shown, including a base 12, a handle 14, a ratchet arm 16 and an adjustable jaw 18. Each of these four main parts are preferably made from sheet steel. Blanks used to form each part are stamped from the sheet steel and are shown, as an exemplary embodiment, in FIGS. 3, 4, 6 and 8. Each blank is cut to shape and then bent using well known sheet-forming tools, including appropriate brakes, stamps, and presses, to form each three-dimensional part.

Referring to FIGS. 1, 2 and 3, and as shown in FIG. 3, the formation of base 12 begins as a flat steel blank 20 (apart from a dashed perimeter cut line, bend lines are shown as dashed lines in the figure), having a front surface 21, a rear surface 22, a top edge 23, and a bottom edge 25 having lower gripping teeth 26, and including two bores 24. Blank 20 is bent upwardly along bend line 28 to create wall 30, and bent upwardly again along bend line 32 to form wall 34. Walls 30 and 34 are formed perpendicular to front surface 21 with each bore 24 aligning with each other and together defining a pivot Axis A. Blank 20 is then bent along bend line 36 rearwardly 90 arc degrees, and again bent 90 arc degrees rearwardly along bend line 38 so that teeth 26 become repositioned under blank 20 facing towards top edge 23, as shown in FIGS. 1 and 2.

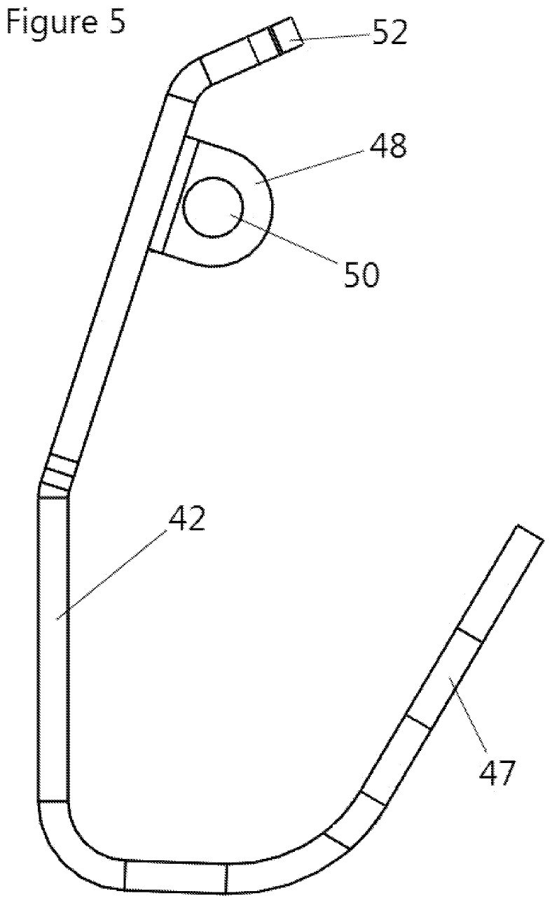

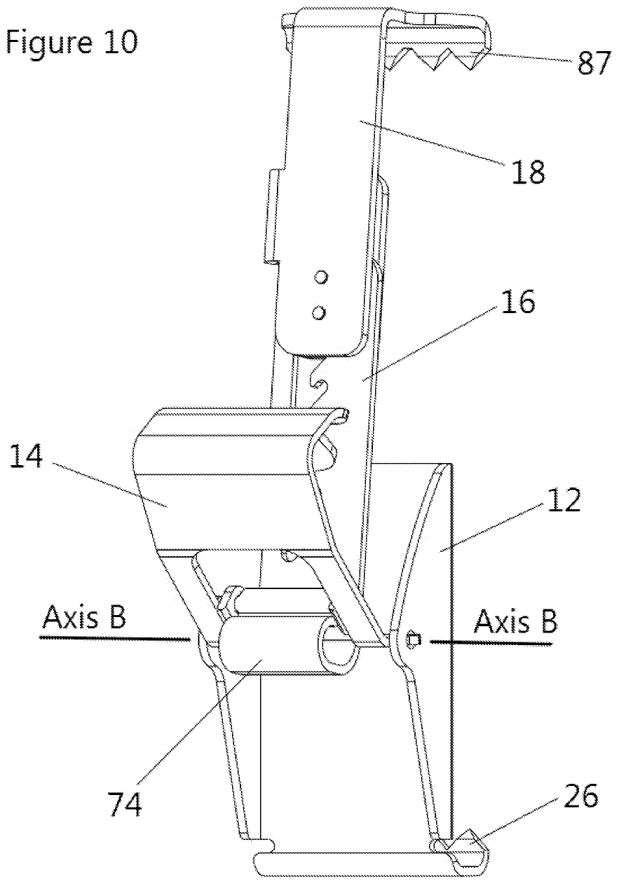

Referring now to FIGS. 1, 2, 4, and 5, as with the above-described base part 12, the formation of handle 14 begins as a flat steel blank 40 (apart from a dashed perimeter cut line, bend lines are shown as dashed lines in the figure), defining an upper surface 42, a pivoting end 44 and a handle end 46, and including two bore-tabs 48, each with a bore 50, and two axle tabs 52. To form handle 14, blank 40 is bent along bend lines 54 to form bore-tabs perpendicular to upper surface 42 and so that bores 50 align with each other and together define pivot Axis B (Axis B is shown in FIGS. 10, 11, 17, and 18). Blank 40 is then bent along bend lines 55, 56, 57 and 58 in various arc degrees to create the general profile shape shown in FIG. 5. The exact bend angles may vary from design to design, as long as an over-center pivoting arrangement is created when this part is assembled with the other parts of clip 10, as described in greater detail below. Pivoting axles 52 are sized and shaped to rotationally fit within bores 24 of base part 12. Handle 14 includes an integrally formed hook 47 at handle end 46, which is sized and shaped to function as a hook for receiving an item intended to be hung on a brick wall.

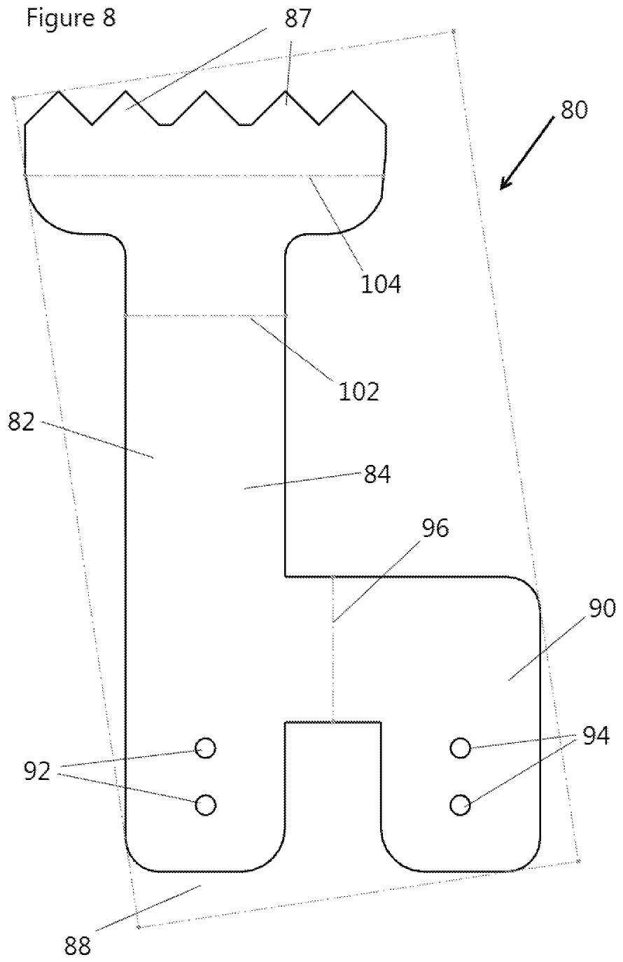

Referring to FIGS. 1, 2, 6, and 7, as with the above-described base part 12, and handle 14, the formation of ratchet arm 16 begins as an elongated flat steel blank 60 (apart from a dashed perimeter cut line, bend lines are shown as dashed lines in the figure), defining an upper surface 61, an upper end 62 and an opposing lower end 63. Blank 60 further includes a stepped ratchet cutout 64 along its length, and axle tabs 71 located adjacent lower end 63. Ratchet cutout 64 includes an elongated sliding channel 69 and angled ratchet teeth 66, which are directed towards upper end 62, as shown in FIGS. 1, 2, 6, and 7. Blank 40 is then bent along bend lines 68, 70, and 72 in various arc degrees, radii, and directions to create the general profile shape shown in FIG. 7, including a spring-loop 74, whose function is explained below. The exact size, shape and thickness (and material choice) for this part may vary from design to design, as long as spring-loop 74 functions as a torsion spring. Axle tabs 71 are sized and shaped (by a well known sheet metal stamping operation) to rotationally fit within bores 50 of handle part 14, as described below.

Referring to FIGS. 1, 2, and 8, as with the other parts, the formation of adjustable jaw 18 begins as a flat steel blank 80 (apart from a dashed perimeter cut line, bend lines are shown as dashed lines in the figure), including a main section 82 having an upper surface 84, a rear surface 85, a top end 86 having upper gripping teeth 87, and an opposing bottom end 88, and a wrap-around section 90 located near bottom end 88. A pair of bores 92 are formed through main section 82, adjacent bottom end 88. A second pair of bores 94 are formed through wrap-around section 90, adjacent bottom end 88.

Blank 80 is bent 180 arc degrees, along bend line 96, so that wrap-around section 90 becomes positioned parallel and adjacent to rear surface 85 of main section 82, as shown in FIGS. 1, 2 and 8. After the bend, pair of bores 92 align with second pair of bores 94, thereby creating a pair of aligned bores 95, each of which is sized and aligned to receive a bore pin 98 (shown in FIG. 1 and described in greater detail below). Wrap-around section 90 is bent about bend line 92 in such a manner that a uniform gap 100 is formed between main section 82 and wrap-around section 90. Gap 100 is sized to snuggly receive ratchet arm 16, as described in greater detail below (the thickness of gap 100 is preferably equal to the thickness of ratchet arm 16). Blank 80 is additionally bent 90 arc degrees about bend line 102 towards rear surface 85, and then bent 90 arc degrees about bend line 104 towards bottom end 88 so that upper gripping teeth 87 are directed towards bottom end 88, as shown in FIGS. 1 and 2.

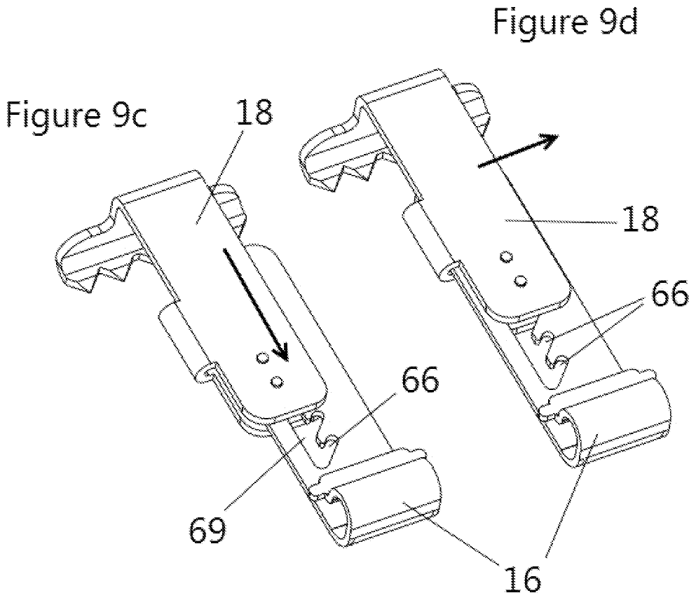

Referring to FIGS. 1, and 9a-9d, as introduced above, and according to the present invention, brick clip hook 10 is made up of four main parts; base 12, handle 14, ratchet arm 16 and adjustable jaw 18. The preferred assembly of these parts is to first insert upper end 62 of ratchet arm 16 into gap 100 of adjustable jaw 18, so that spring-loop 74 of ratchet arm 16 is positioned upward and remote from bottom end 88 of adjustable jaw 18, as shown in FIGS. 9a-9d. Upper gripping teeth 87 are directed downwardly, opposite spring-loop 74. Pair of aligned bore holes 95 of adjustable jaw 18 are then positioned so that they align with ratchet cutout 64. Once aligned, a bore pin 98 is pressed into each pair of aligned bore holes 95, passing through ratchet cutout 64, and not penetrating the sheet metal that makes up ratchet arm 16. Pins are preferably made from steel, but may be made from any appropriate material and may be secured within holes 95 with a 100% (or greater) tolerance fit. Alternatively, the exposed ends of inserted pins 98 may be peened in place thereby flattening the ends and binding the pins in place. Bore pins 98 may also be rivets or threaded fasteners. Regardless, bore pins 98 are sized to fit within ratchet teeth 66 of ratchet cutout, thereby allowing a user to selectively engage the portions of bore pins 98 located within gap 100 with any of ratchet teeth 66 by first sliding adjustable jaw 18 to the left (with respect to ratchet arm 16, as shown in FIGS. 9a and 9b. This will relocate bore pins 98 into sliding channel 69. Next, adjustable jaw 18 is then slide downwardly towards spring-loop 74 so that bore pins 98 slide down within sliding channel 69, as shown in FIG. 9c. Once a desired location has been reached, the user then slides adjustable jaw 18 to the right, with respect to ratchet arm 16, thereby forcing the two bore pins 98 into a different pair of ratchet teeth 66 or ratchet arm 16, as shown in FIG. 9d. This will be described again in the “In Use” section below.

Once the ratchet arm 16 is slidingly attached to adjustable jaw 18, as described above, ratchet arm 16 is then secured to handle 14 by inserting axle tabs 71 of ratchet arm 16 into bores 50 of bore tabs 48 of handle 14, as shown in FIG. 1, so that handle end 46 is directed upward and opposite upper gripping teeth 87. One or both of the two bore tabs 48 may have to be bent open a bit to allow axle tabs 71 to be inserted. The bent bore tabs 48 are then returned to their original position, thereby capturing axle tabs 71 within bores 50 and also pivotally attaching ratchet arm 16 (and also adjustable jaw 18) to handle 14. The size and shape of axle tabs 71 and bores 50 are such that relative pivotal displacement is provided between handle 14 and ratchet arm 16.

Finally, handle 14, with its connected ratchet arm 16 and adjustable jaw 18 are pivotally attached to base 12 by inserting axle tabs 52 into bores 24 of walls 34 of base 12, as shown in FIG. 1, so that handle end 46 is directed upward and adjacent to lower gripping teeth 26. One or both of the two walls 30, 34 may have to be splayed open a bit to allow axle tabs 52 to be inserted. The walls 30, 34 should spring back to their original shape, but may have to be bent, depending on the type of steel used. Once the walls 30, 34 spring back to their original vertical position, as shown in FIG. 1, axle tabs 52 of handle 14 will then be captured within bores 24, along with ratchet arm 16 and adjustable jaw 18. The size and shape of axle tabs 52 and bores 24 are such that relative and snug pivotal displacement is provided between handle 14 and base 12. Handle 14 should feel tightly attached to base 12, but yet should still be permitted to freely pivot about Axis A. The use of axle tabs 52 and 71, and bores 24 and 50 allow for effective pivoting movement of the required parts, with respect to each other, yet also allow the entire assembly to be quickly and easily assembled. Axle pins or rivets (not shown) could be used in place of axle tabs 52 and 71, but would require more extensive assembly procedures and more parts.

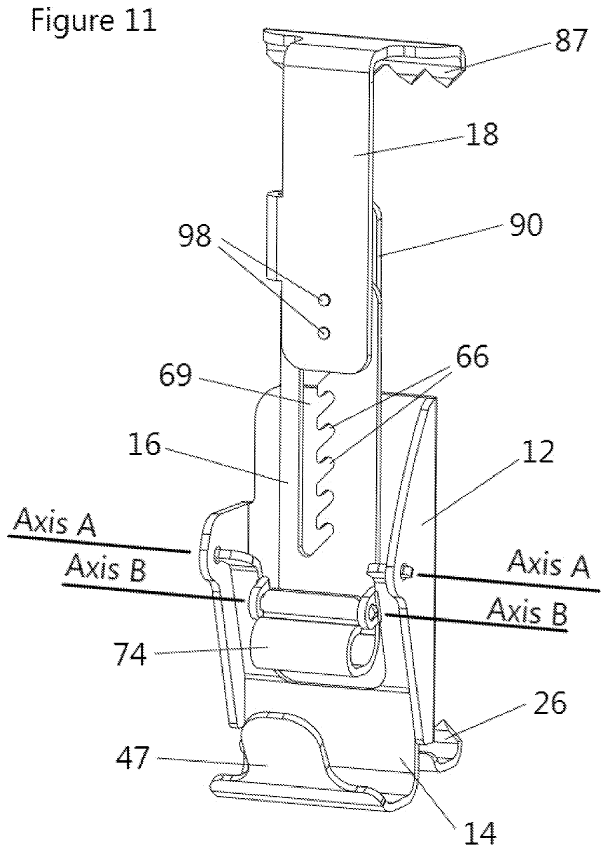

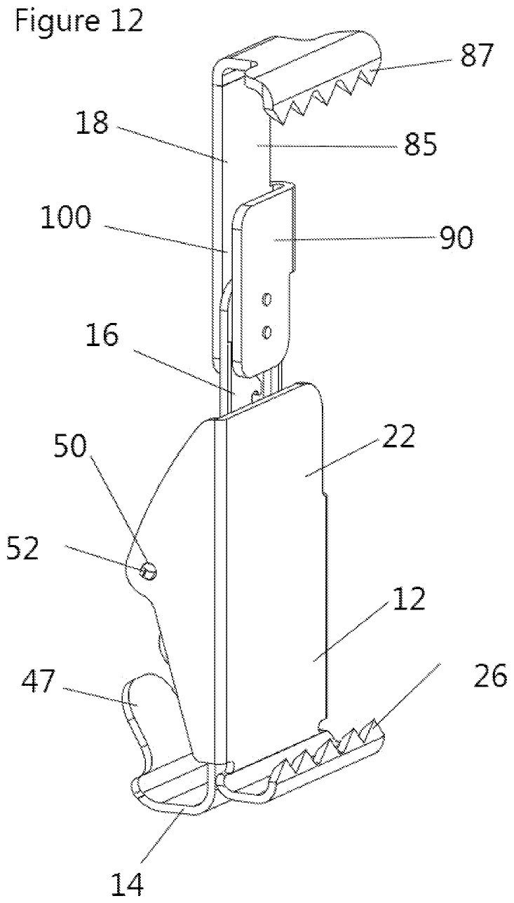

Referring to FIGS. 2, 10, 11, and 12, as assembled, handle 14 (including pivotally attached ratchet arm 16 and slidably attached adjustable jaw 18) may pivot with respect to base 12 between an open position, as shown in FIGS. 2 and 10, and a closed position, as shown in FIGS. 11 and 12. As handle 14 pivots between these two positions, the distance between upper gripping teeth 87 and lower gripping teeth 26 changes from a minimum distance (a clamping distance) and a maximum distance (fully open). The amount of movement between the jaws between the open and closed position (hereinafter called: “clamping distance”) is equal to twice the distance measured between the center of bore 24 and the center of bore 48. The maximum (or fully open distance) may be changed by the user by adjusting (sliding) adjustable jaw 18 with respect to ratchet arm 16, as mentioned above and as shown in FIGS. 9a-9d. This allows the user to quickly and easily adjust the jaw opening size until it reaches across the height of a select brick of the brick wall. When the user closes the clip about the brick by moving the handle down, as explained below, the upper and lower teeth will displace (or try to displace) into the brick a distance equal to the “clamping distance.” However, since brick does not compress, the compressive force is diverted to spring loop 74, which functions as a torsion spring, as explained below.

Also, as handle pivots between these two positions (open and closed), ratchet arm 16 and connected adjustable jaw 18 are pivotal together, as well. This is important when a user attaches brick clip hook 10 to a brick 110 of a brick wall 112, because the user can independently pivot upper teeth into an upper bed joint of the brick wall, as explained below.

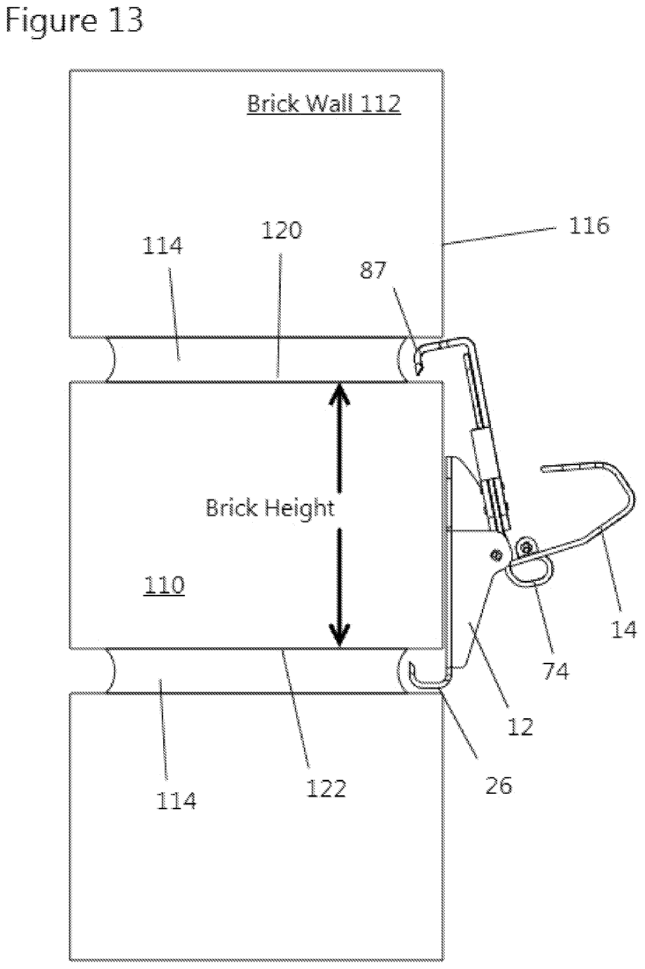

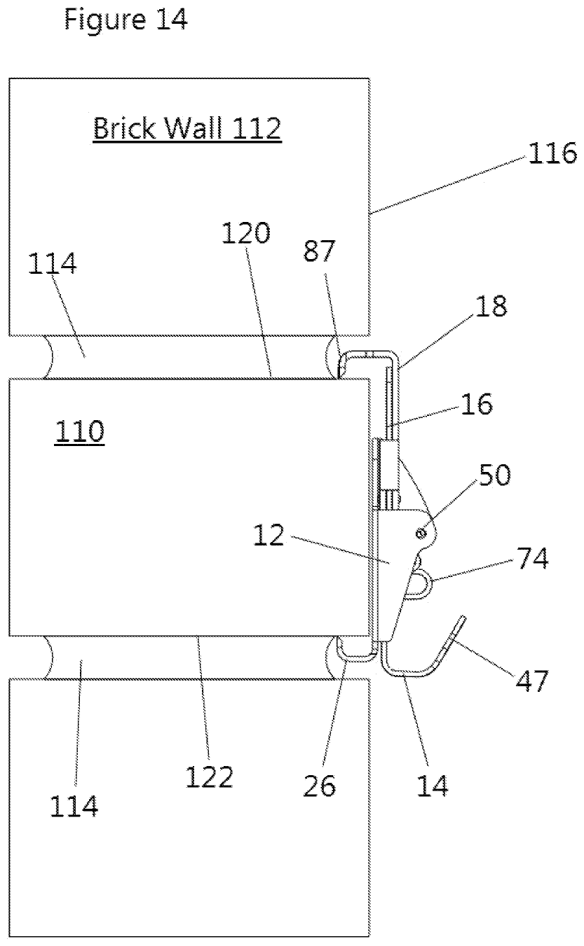

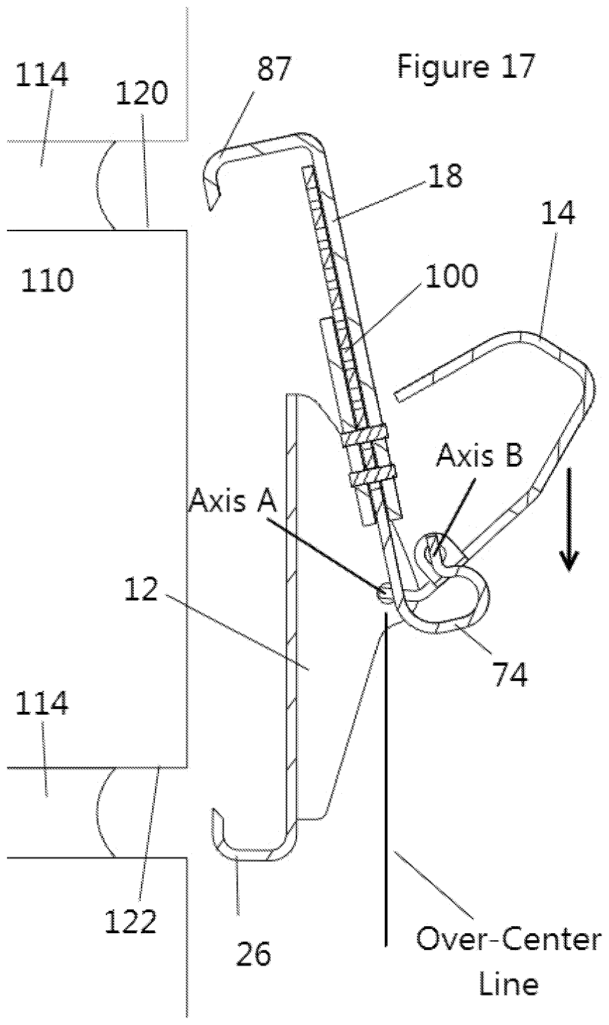

In use, As mentioned above, brick clip hook is designed to quickly and easily clip onto a select brick 110 of a brick wall 112 by fitting within horizontal and adjacent bed joints located between rows of brick. Referring to FIGS. 13, 14, 17 and 18, an exemplary brick wall 112 is shown having three illustrative bricks 110, with interposed bed joints 114 and a brick surface 116. Use of the present brick clip hook 10 is straight-forward and it may be quickly and easily adjustable to accommodate various size bricks. Referring to FIG. 13, a user first positions brick clip hook 10 against a select brick 110 of brick wall 112 so that rear surface 22 of base part 12 contacts surface 116 of brick 110 and so that lower gripping teeth 26 of base 12 becomes positioned within a lower bed joint 114 (the lower part of select brick 110), while upper gripping teeth 87 of adjustable jaw 18 is adjusted up and down, as described above, and shown in FIGS. 9a-9d, until it fits within an upper bed joint (the upper part of select brick 110). Once both upper and lower gripping teeth are positioned within adjacent bed joints, as shown in FIGS. 13 and 17, the user pivots handle end 46 down about pivoting Axis A until handle 14 is at the closed position, as shown in FIG. 14. As handle end 46 is pushed down, upper and lower gripping teeth move towards each other causing gripping teeth to firmly clamp onto select brick 110. When handle end 46 is at the closed position, hook 47 will be oriented correctly to become a functional hook for receiving an item intended to be hung, or an appropriate cable or cord 130 attached to an item to be hung. It should be noted that the exact size and shape of hook 47 may vary depending on the design and what types of items the brick clip hook is meant to support. Gripping teeth will firmly grip onto brick 110 so that even lateral forces, such as the forces created by strong wind, will be discouraged from dislodging brick clip hook 10 from the brick it has clamped onto.

Also, the user may easily remove brick clip hook 10 by simply lifting handle end 46 from the closed position to the open position, shown in FIG. 13. When this is done, handle 14 will cause upper gripping teeth 87 to move away from lower gripping teeth 26, which will loosen clip 10 from brick 110.

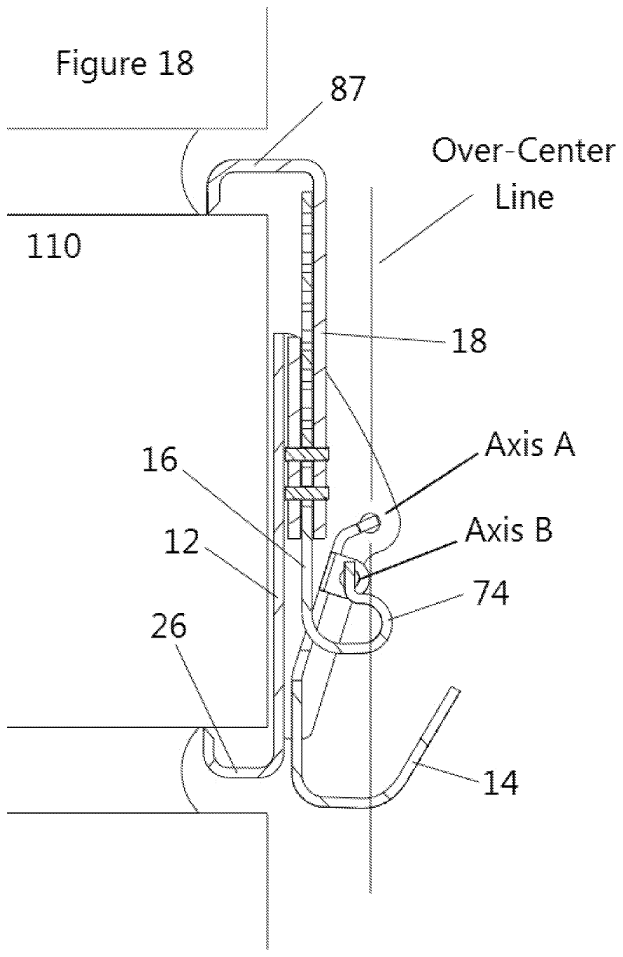

Referring to FIGS. 17 and 18, the present brick clip hook 10 is shown in sectional view to reveal the inner workings of the mechanism at the open and closed positions. As shown in FIG. 17, handle 14 is in the open position, and owing to the relative pivot connection between handle 14 and ratchet arm 16 at Axis B, and the pivot connection between handle 14 and base 12 at Axis A, the handle in the open position has mechanically forced ratchet arm 16, and attached adjustable jaw 18 up and away from lower gripping teeth 26, making the distance between the two sets of teeth further apart. This allows the user to expand clip 10 so it can be positioned about select brick 110.

As mentioned above, the relative position of adjustable jaw 18 with respect to ratchet 16 may be quickly and easily changed by sliding adjustable jaw 18 to the left to release pins 98 from their engagement with two select angled ratchet teeth 66. Once pins are positioned within elongated sliding channel 69 of ratchet cutout 64, adjustment jaw 18 may slide up and down, as illustrated in FIGS. 9a-9d, and relocked by sliding adjustment jaw 18 to the right, with respect to ratchet arm 16 and re-engaging pins 98 into a new pair of angled ratchet teeth 66. Since the angled ratchet teeth 66 are oriented towards upper teeth 87, then when handle 14 is pressed down to move the clip to the closed position, pins 98 will fall into and tightly engage the selected angled ratchet teeth and cause ratchet arm to lock into place with respect to adjustable jaw 18.

Once the user positions brick clip hook 10 against wall 112 so that upper gripping teeth 87 and lower gripping teeth 26 are positioned within adjacent bed joints 114 of the wall, handle 14 may be rotated downward, about Axis B. Clockwise rotation of handle 14 mechanically pulls ratchet arm 16, and attached adjustment jaw downward towards base 12. As the distance between upper and lower gripping teeth decreases, eventually both sets of teeth 26, 87 will engage with an upper surface 120 and a lower surface 122 of brick 110. As the user continues to move handle 14 down, the compression of teeth 26, 87 against brick 110 continues. Spring loop 74 has been deliberately formed physically between upper teeth 26 and the axle tabs 71 which connect to handle 14 so that it will function as a torsion spring and used to absorb excess compressive forces and thereby prevent the forces from damaging the components of clip 10. Spring loop 74 essentially determines the maximum compressive force that can be applied to brick 110 by brick clip hook 10. As spring loop 74 loads up with compressive force, this force will be translated, as torque and applied to handle 14. In other words, when the gripping teeth 26, 87 first bite into brick 110 as far as they can (since brick is not compressive), the user will begin to feel spring resistance (torque) in the handle 14, as the user continues to rotate the handle down. The magnitude of the torque applied to handle 14 will be equal to the magnitude of compressive force being absorbed by spring-loop 74. As handle 14 continues to be rotated downward, against the torque of spring loop 74, Axis B will eventually pass Axis A (thereby passing the “Over-Center Line”, shown in FIG. 17). As this point, the direction of the torque from spring-loop 74 applied to handle 14 will reverse and will now bias handle 14 to the closed position, likely with a resounding “snap,” as shown in FIG. 18. As long as Axis B remains “below” the Over-Center Line (that is, on the side of the line that is closer to upper surface 21 of brick clip hook 12, using FIG. 18, as a reference), the torque applied to handle 14 will keep handle 14 in its closed position, and also keep brick clip hook 10 firmly clamped to brick 110. The tension built-up in spring-loop 74 will continue to exert a compressive force to brick 110 and firmly hold brick clip hook 10 to brick 110.

To release brick clip hook 10, a user merely has to pull up on handle 14, against the torque of spring-loop 74, until Axis B passes Axis A (the Over-Center Line), at which point the direction of torque from spring-loop 74, about Axis B will reverse and will now bias handle towards the open position, as shown in FIG. 17.

The exact dimensions and shapes of base 12, handle 14, ratchet arm 16 and adjustable jaw 18 can vary without departing from the gist of the invention. Hook 47 may be formed larger or deeper, depending on the particular application and item intended to be hung. Spring loop 74 may be made more firm (by using thicker steel and making the ratchet arm wider, or using a different type of metal (or plastic) and also by controlling the heat treatment of the parts. By changing these variables, brick clip hook 10 can be made stronger since the energy stored in the stronger spring-loop 74 will apply a stronger compressive force to the brick, once attached.

As mentioned above, the preferred material for all the parts of brick clip hook (base 12, handle 14, ratchet arm 16 and adjustable jaw 18) is steel, owing to its cost, workability, and strength, and the particular application of gripping onto brick. Different alloys of steel may be used, including spring steel. Other types of metals and other materials (plastic) may be used, as long as they are designed to perform for the intended purpose.

If steel parts, the parts should be heat-treated to create hardened parts so that the parts can withstand the compressive and rotational forces applied to them during use. Heat treating metals for hardness and tempering them is well known by those of ordinary skill in the art, and the specific details of the processes are beyond the scope of this patent application. The parts of the present brick clip hook must be strong and hard (yet not brittle) to resist flexure or other deformation during use and also to allow gripping teeth 87, 26 to effectively grip into the brick surfaces. It is suggested that the brick clip hook 10 is fully assembled prior to heat treatment so that the parts remain a bit pliable during assembly. Spring-loop 74, although preferably hardened to resist flexure will still deform, like a coil spring, owing to its size and shape. The stronger spring-loop is made, the stronger the clamping force applied to the brick.

As mentioned above, the present brick clip hook may be made from a strong plastic, such as Zytel®, reinforced with 20% glass fibers. In such instance, the parts would likely require thicker regions and reinforcing ribs and other such design structures so that the parts can function as intended without failure and unwanted flexure. Applicant envisions a clamping structure similar to the brick clip hook but made from plastic, as described, and having flat contact pads, in place of upper and lower gripping teeth. The application in this instance would be for providing a hook onto a wooden mantel (over a fire place) so that items, such as Christmas stockings may be quickly and easily hung from the mantel using such modified clips 10 without damaging the delicate wood. The gripping distance feature of the present brick clip hook 10 would still be useful in this new application for allowing the mantel clip to accommodate mantels of different thicknesses.

What is claimed is:

1) A clamping wall hook for selectively securing to a brick, the brick being of the type including a front face, a top surface and a bottom surface, and defining a first distance measured between the top surface and the bottom surface, the wall hook comprising:
a base, having lower teeth adapted to selectively engage the bottom surface of the brick, the lower teeth being located within a gripping plane;
a handle, pivotally attached to the base along a first axis between a locked position and an unlocked position, the handle including a hook;
an upper jaw member, pivotally attached to the handle along a second axis and having upper teeth adapted to selectively engage the top surface of the brick, the upper teeth being positionable within the gripping plane, the second axis rotating about the first axis when the handle pivots between its locked and unlocked positions, the upper teeth are spaced apart from the lower teeth a second distance which is greater than the first distance when the handle is in the unlocked position and when lower and upper teeth are aligned within the gripping plane, the upper teeth are spaced apart from the lower teeth a third distance which is less than the first distance when the handle is in the locked position and when lower and upper teeth are aligned within the gripping plane, the upper jaw member further having a spring for forcing the upper teeth towards the lower teeth, thereby allowing the wall hook to selectively grip onto the top and bottom surfaces of the brick.

2) The clamping wall hook of claim 1, wherein the spring is formed integrally with the upper jaw member.

3) The clamping wall hook of claim 1, wherein the handle, base and upper jaw member are made from a strong resilient material.

4) The clamping wall hook of claim 3, wherein the material is hardened steel.

5) The clamping wall hook of claim 1, wherein the relative position of the first axis with respect to the second axis creates an over-center action, so that a longitudinally oriented tension force causes the handle to maintain its locked position, when the wall hook is secured to a brick.

6) The clamping wall hook of claim 1, wherein the upper jaw member further includes a linear adjustment mechanism that allows the distance between upper teeth and lower teeth to be linearly adjusted in predetermined increments.

7) The clamping wall hook of claim 6, wherein the linear adjustment mechanism includes two sliding plates, a first plate includes a ratchet having at least two engagement notches and a second plate includes a pin, the pin being sized and positioned to selectively engage at least one of the at least two engagement notches.

8) The clamping wall hook of claim 1, wherein the hook is sized and shaped to function as a support for hanging an item.

9) A clamping wall hook for selectively securing to a brick, the brick being of the type including a front face, a top surface and a bottom surface, and defining a first distance measured between the top surface and the bottom surface, the wall hook comprising:
a base, having lower teeth adapted to selectively engage the bottom surface of the brick;
a handle, pivotally attached to the base between a locked position and an unlocked position, the handle including a hook;
an upper jaw member having upper teeth adapted to selectively engage the top surface of the brick, the upper jaw member pivotally attached to the handle so that when the handle is in the unlocked position, the distance between the upper and lower teeth is greater than the first distance, and when the handle is in the locked position, the distance between the upper and lower teeth is less than the first distance; and
a spring bias arranged to force the upper teeth towards the lower teeth, thereby allowing the wall hook to selectively grip onto the top and bottom surfaces of the brick, when the handle is in the locked position.

10) The clamping wall hook of claim 9, wherein the spring bias is a spring that is formed integrally with the upper jaw member.

11) The clamping wall hook of claim 9, wherein the handle, base and upper jaw member are made from a strong resilient material.

12) The clamping wall hook of claim 11, wherein the material is hardened steel.

13) The clamping wall hook of claim 9, wherein handle is pivotally attached to the base along a first axis and the upper jaw member is pivotally attached to the handle along a second axis, the relative position of the first axis with respect to the second axis creates an over-center action which holds the handle in its locked position when the wall hook is secured to a brick.

14) The clamping wall hook of claim 9, wherein the upper jaw member further includes a linear adjustment mechanism that allows the distance between upper teeth and lower teeth to be linearly adjusted in predetermined increments.

15) The clamping wall hook of claim 14, wherein the linear adjustment mechanism includes two sliding plates, a first plate includes a ratchet having at least two engagement notches and a second plate includes a pin, the pin being sized and positioned to selectively engage at least one of the at least two engagement notches, one of the first and second plate is connected to the upper teeth and the other of the first and second plate is connected to the handle.

16) The clamping wall hook of claim 9, wherein the hook is sized and shaped to function as a support for hanging an item.

17) A clamping wall hook for selectively securing to a wall structure, the wall structure including a front face, a top surface and a bottom surface, and defining a first distance measured between the top surface and the bottom surface, the wall hook comprising:
a base, having lower teeth adapted to selectively engage the bottom surface of the wall structure;
a handle, pivotally attached to the base between a locked position and an unlocked position, the handle including a hook;
an upper jaw member having upper teeth adapted to selectively engage the top surface of the wall structure, the upper jaw member pivotally attached to the handle so that when the handle is in the unlocked position, the distance between the upper and lower teeth is greater than the first distance, and when the handle is in the locked position, the distance between the upper and lower teeth is less than the first distance; and
a spring bias arranged to force the upper teeth towards the lower teeth, thereby allowing the wall hook to selectively grip onto the top and bottom surfaces of the wall structure, when the handle is in the locked position.

18) The clamping wall hook of claim 17, wherein the hook is sized and shaped to function as a support for hanging an item.
